(19) United States
(12) Patent Application Publication
(10) Pub. No.: US 2010/0122515 A1
(43) Pub. Date: May 20, 2010

(54) POISON-FILTER MATERIAL AND PRODUCTION METHOD THEREOF

(76) Inventors: Han-Wen Kuo, Xizhi City (TW); Jin-Feng Wang, Longtan Shiang (TW); Feng-Mei Fang, Taoyuan City (TW); Jen-Chin Wu, Zhongli City (TW); Shiaw-Ruey Lin, Xizhi City (TW); Yuh Sung, Zhongli City (TW); Chen-Chia Huang, Douliu City (TW); Chun-Yu Kao, Gukeng Shiang (TW); Chien-Hung Chen, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/273,538

(22) Filed: Nov. 18, 2008

(51) Int. Cl. B01D 39/14; B05D 3/02; B01D 39/16

(52) U.S. Cl. 55/524; 427/226

(57) ABSTRACT

The poison-filter material of the invention includes a substrate and a metal oxide. The substrate includes numerous holes, and the metal oxide is adhered to a surface of the substrate and the holes. The method for producing the poison-filter material of the invention includes the following steps of sonicating and impregnating a substrate into a metallic salt aqueous solution; and calcining the substrate to form a metal oxide on a surface of the substrate and numerous holes of the substrate, such that the poison-filter material is produced. In the invention, the metallic salt aqueous solution is fully oscillated to impregnate the porous substrate, and metal oxide is formed on the surface and holes of the substrate after high-temperature calcination. Therefore, the adsorbent material of the invention can effectively adsorb noxious gas and lower penetrability of noxious gas. During the calcination process, the metallic salt aqueous solution of the invention does not generate harmful volatility solvent such as ammonia. Therefore, the invention can prevent the production process from polluting the environment, harming the health of operator, and reduces the cost for recycling harmful volatility solvents.

### BACKGROUND OF THE INVENTION

1. Field of the Invention

The invention relates to a material and a production method thereof, and particularly to a poison-filter material and production method thereof. The poison-filter material of the invention can be applied to gas protection equipment in the military, gas purification in manufactory, and an air cleaner in home and car.

2. Description of the Prior Art

U.S. Pat. No. 3,355,317 (title: Process of impregnating adsorbent materials with metal oxides) mainly discloses an adsorbent material containing metal oxides. The adsorbent material is produced from a porosity substrate having a high surface to volume ratio by an impregnation process and a sinter skill. The adsorbent material can be applied to cigarette filters for filtering smoke which contains chemical matter such as HCN and H₂S. Metallic salts such cobalt salt, copper salt, zinc salt, ferric salt, molybdenum salt, and silver salt is dissolved in the ammonia to produce an impregnation stock solution. The activated carbon is impregnated in the stock solution with a single metallic salt or two metallic salts once, or impregnated in the stock solution with two metallic salts twice. Then, the activated carbon is processed at a high-temperature to remove the surplus solvent, and meanwhile the metallic salt will adhere on the porosity substrate can be transformed in to a metal oxide.

This patent (in the prior art) utilizes adsorbent materials containing metal oxide to process a noxious gas, but the ratio of solvent to the impregnation solution and impregnation method of the substrate are distinctly different from the invention. The invention only utilizes de-ionized water to produce impregnation stock solution without containing ammonia or other organic solvent. Therefore, the impregnation stock solution of the invention not only decreases thrill smell, but also the gases produced from the stock solution after impregnating and produced from a drying process and are easily processed. Additionally, the invention utilizes a sonication vessel to oscillate and stir the impregnated substrate for a long time, so the invention does not have the disadvantage of the shorttime impregnation method (e.g. the metal oxide is only adhered to the surface of the substrate in the prior art).

U.S. Pat. No. 4,531,953 (title: Sublimation of amine compounds on activated carbon pore surface) discloses ASC impregnated activated carbon impregnating/subliming amine matter, and discloses absorption results of two gases (CNCL and chloropicrin (PS)) being adsorbed by the ASC impregnated activated carbon impregnating/subliming amine material. M11 canisters are used in the absorption experiments, and the absorption experiments discloses absorption times of ASC impregnated carbon, ASC-TEDA impregnated carbon, ASC-quinuelidine impregnated carbon, and other activated carbons respectively absorbing cyanogen chloride (CK) gas before/after aging. The experiment results show that these two amine matters can extend the absorption time of ASC impregnated carbon for absorbing the CK gas, and show that the absorption effect of ASC impregnated carbon is still well after aging. This patent (the prior art) mainly discloses organics subliming to impregnated activated carbon, and is distinctly different from adsorbent material containing in-organics (metal oxide) disclosed by the invention. The mechanism of adsorbing and dissociating noxious gas disclosed in this patent (the prior art) is also distinctly different from the invention. The production process of adsorbent material in the invention also is different from prior patent. The prior patent makes use of the sublimation/fumigation method to process the amine matter, and the invention firstly produces a metallic salt solution and then impregnates the substrate in the solution.

U.S. Pat. No. 5,063,196 (title: Chromium-free impregnated activated carbon for absorption of toxic gases and/or vapors) discloses the production method of chromium-free impregnated activated carbon and the absorption result of the impregnated activated carbon absorbing the noxious gas. This prior patent uses an activated carbon as a substrate, and producing impregnated activated carbon containing Cu, Zn, Ag, TEDA(triethylenediamine), and tartaric acid by a two-time impregnation method. This prior patent also discloses the absorption results of activated carbons impregnated with different ratios of impregnation materials respectively absorbing HCN, CNCl, HCl, SO₂, and CH₂O. This prior patent also discloses the lifespans of ASC activated carbon and ASZ-TEDA activated carbon affected by moisture and aging. In this prior patent, the ammonia is used as the solvent of the impregnation solution, so the impregnation solution in the prior patent is distinctly different from the impregnation solution without thrilling solvent in the invention. Additionally, heating temperature, heating time, and purpose in the prior patent are different from the invention. The heating of material in the prior patent is used for removing solvent, so the heating temperature is lower than 200° C. However, the heating of material in the invention is used for forming the metal oxide, and the material is heated to a high temperature. Furthermore, the mechanism of adsorbing and dissociating noxious gas disclosed in this prior patent is also distinctly different from the invention.

U.S. Pat. No. 4,521,530 (title: Catalyst of palladium, copper and nickel on a substrate) discloses a bauxite catalyst impregnated with PdCl₂, and discloses how to enhance/keep the reaction effect of the bauxite catalyst for absorbing noxious gas (e.g. CO, H₂S, HCN, SO₂, and O₃) under a condition of reducing PdCl₂. This prior patent uses PdCl₂ solution added with different metallic salts such as NiCl2, CuCl2, and CuSO4 to produce an impregnation solution, and uses CO gas to test the elimination rate (oxidation, dissociation, and absorption) of the bauxite catalyst. The substrate in this patent is only impregnated for a short time, but the substrate in the invention is oscillated, stirred, and impregnated for a long time. Additionally, the adsorbent material in this prior patent is heated for evaporating water of the substrate, but the substrate in the invention is heated for forming the metal oxide and heated to a high temperature.

U.S. Pat. No. 6,383,972 (title: Preparation of a catalyst support in activated carbon fibers) discloses a production method of an activated carbon fiber adhered with metallic catalyst. In this prior patent, firstly, an activated carbon fiber fabric is made from a fiber fabric with a rayon material, made by a high-temperature heating process, and the BET (surface to volume ratio) of the activated fiber fabric is larger than 1200 m²/g. Then, the activated carbon fiber reacts with rubidium salt solution under a cationic exchange method or a liquid impregnation and dis-oxidation method to produce an activated carbon fiber containing metallic catalyst. The main purpose of this prior patent is to produce the activated carbon fiber containing a metallic catalyst, and the activated carbon fiber is applied to a specific catalyst reaction. However, the main purpose of the invention is to produce the activated carbon fiber containing metal oxide, and the activated carbon fiber is applied to the absorption and dissociation of micro-molecule gas such as aldehydes. This prior patent uses the ion exchange method and the impregnation method making unmodified metal adhere to the activated carbon fiber. However, the invention uses the sonication, stirring, and impregnation method to produce the adsorbent material. The invention uses a chemical reagent to after-treat the impregnation matter, such that Ru3+ is returned to a metallic state. However, the after-treatment in the invention is to transform the impregnation matter to the metal oxide at a high temperature.

To enhance the absorption ability of porous material such as the activated carbon, the bauxite, or the molecule sieve for absorbing noxious matter existed in the industrial environment, the civil environment, and chemical warfare, the porous material generally is treated with an impregnation method to enhance the chemical absorption ability and extend the lifespan. In an early stage, the adsorbent material is an impregnated activated carbon material containing chromium mixed with other metals such as silver, copper, and zinc. Prior patents and journals disclose many inventions and researches with relation to adsorbent material. However, environmental consciousness has risen rapidly in recent years, so heavy metal such as hexad-chromium is highly inhibited. Therefore, some chemical matters disclosed in prior patents and inventions will break the law, and the chromium-containing waste is a huge recycling problem.

Accordingly, in the later stage, patents and inventions about adsorbent materials with high absorption ability mainly utilize non-inhibited metals such as copper, silver, zinc, molybdenum, and vanadium instead of hexad-chromium, and utilize the adsorbent material is impregnated with organic amine salt to reach the absorption ability of chromium-containing adsorbent material, even to increase the lifespan. However, some patents use alkali metallic salt for producing an impregnation solution, but these alkali metallic salts are only well-distributed in the ammonia solvent. The processing of the impregnated adsorbent material is a huge problem. High-temperature drying or solvent-removing equipment has to be configured with recycling devices for recycling the alkali solvent. The production costs will be increased, and this production process has risks of harming the operator's health and polluting the environment. Although organic amine salt can raise the absorption ability of the adsorbent material, if the adsorbent material still is wet, because the amine salt on the adsorbent material could be heated and sublimed, the adsorbent material can not dehydrate under the high-temperature environment. These problems are disadvantages of these patents and inventions about adsorbent material in the later stage.

The invention provides a poison-filter material and the production method thereof. In the invention, the metallic salt aqueous solution (e.g. nitrite salt aqueous solution) is fully oscillated to impregnate the porous substrate (e.g. activated carbon fiber with holes), and metal oxide is formed on the surface and holes of the substrate after high-temperature calcination. Therefore, the adsorbent material of the invention can effectively adsorb noxious gas and lower penetrability of noxious gas. During the calcination process, the metallic salt aqueous solution of the invention does not generate harmful volatility solvents such as ammonia. Therefore, the invention can prevent the production process from polluting the environment, harming the health of operator, and reduces the cost for recycling harmful volatility solvents.

### SUMMARY OF THE INVENTION

A scope of the invention is to provide a poison-filter material and a production method thereof. The metallic salt aqueous solution (e.g. nitrite salt aqueous solution) is fully oscillated to impregnate the porous substrate (e.g. activated carbon fiber with holes), and metal oxide is formed on the surface and holes of the substrate after high-temperature calcination. Therefore, the adsorbent material of the invention can effectively adsorb noxious gas and lower penetrability of noxious gas.

Another scope of the invention is to provide a poison-filter material and a production method thereof. The metallic salt aqueous solution does not generate harmful volatility solvents such as ammonia during the calcination process. Furthermore, the invention can prevent the production process from polluting the environment, harming the health of operator, and reduces the cost for recycling harmful volatility solvents.

The poison-filter material of the invention includes a substrate and a metal oxide. The substrate includes a plurality of holes, and the metal oxide is adhered to a surface of the substrate and the holes. The production method for producing the poison-filter material of the invention includes the following steps of: sonicating and impregnating a substrate into a metallic salt aqueous solution; and calcining the substrate to form a metal oxide on a surface of the substrate and numerous holes of the substrate, such that the poison-filter material is produced.

The advantage and spirit of the invention may be understood by the following recitations together with the appended drawings.

### BRIEF DESCRIPTION OF THE APPENDED DRAWINGS

FIG. 1 is a cross-section view of a poison-filter material of the invention.

FIG. 2 is a flow chart of producing the poison-filter material of the invention.

FIG. 3 is a scheme illustrating the dynamic absorption testing device of the invention.

FIG. 4 is a SEM figure of an activated carbon fiber modified by magnesia.

FIG. 5 is a FTIR spectrum of the activated carbon fiber fabric.

FIG. 6 is a breakthrough time curve of phenolic resin-precursor activated carbon fiber fabric for dynamically absorbing acetaldehyde.

FIG. 7 is a breakthrough time curve of PAN-precursor activated carbon fiber fabric for dynamically absorbing acetaldehyde.

FIG. 8 is a breakthrough time curve of activated carbon fiber fabric modified by magnesia for absorbing acetaldehyde.

### DETAILED DESCRIPTION OF THE INVENTION

The invention provides a poison-filter material and a production method thereof, and the absorption and dissolution ability of the porous material of the invention is raised with regards to the acetaldehyde molecule. Furthermore, the lifespan of the porous time is extended, the production process is simplified, and the environmental pollution generated from the production process is reduced. The invention regards an activated carbon fiber with a high surface to volume ratio as a substrate, and regards metallic (e.g. magnesium, cobalt, aluminum) nitrate salt aqueous solution as an impregnation solution. The metallic salt is impregnated in the micro holes of the substrate or adhered to the surface of the substrate by an impregnation skill. Then, metal oxide is transformed from the metallic salt by high-temperature calcination skill. Compared with prior patents, the invention does not use chromium as an impregnation matter, and uses water as a solvent to prevent secondary environmental pollution. The activated carbon and the bauxite are used in the early stage, but the invention uses an activated carbon fiber with a high surface to volume ratio (BET≧1500 m²/g) instead. The activated carbon fiber with a high surface to volume ratio not only has a large contact area and a large amount of micro-pores (diameter≦2 nm) to highly raise exposure of the activated substrate, but also has a lighter weight and is not dusty, such that it can be easily processed to form any shape for product.

Additionally, the invention includes dynamical absorption simulations and experiments for the noxious gases, and these simulation results and experiment results are helpful for determining the absorption ability of the adsorbent material. Although some prior patents have proceeded breakthrough-time experiments for noxious gases, the prior patents do not have a complete absorption curve and simulation data.

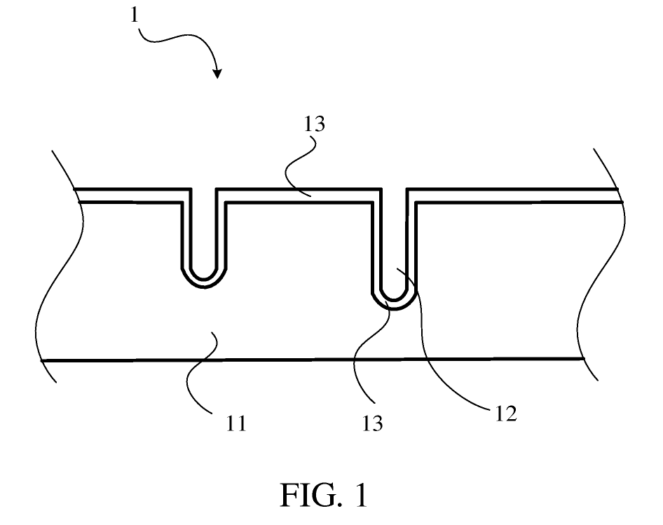

As shown in FIG. 1, the poison-filter material 1 of the invention includes a substrate 11 and metal oxides 13. The substrate 11 has several holes 12, and the metal oxides 13 are adhered to the surface of the substrate 11 and in the holes 12. The substrate 11 is an activated carbon substrate, and selected from the group consisting of a granular activated carbon, a columnar activated carbon, and a fibrous activated carbon. The surface to volume ratio of the fibrous activated carbon is larger than or equal to 1500 m²/g, and the diameters of the holes of the fibrous activated carbon are smaller than or equal to 2 nm. The fibrous activated carbons constitute an activated carbon fiber fabric, and the activated carbon fiber fabric is selected from the group consisting of a phenolic-precursor activated carbon fiber fabric and an acrylic activated carbon fiber fabric. The activated carbon fiber fabric preferably is the acrylic activated carbon fiber fabric. The metal oxide is selected from the group consisting of a cobalt oxide, an aluminum oxide, a magnesia, a copper oxide, a ferric oxide, a zinc oxide, and a nickel oxide, and the cobalt oxide is a tricobalt tetraoxide. A preferred metal oxide is magnesia among the tricobalt tetraoxide, the aluminum oxide, and the magnesia.

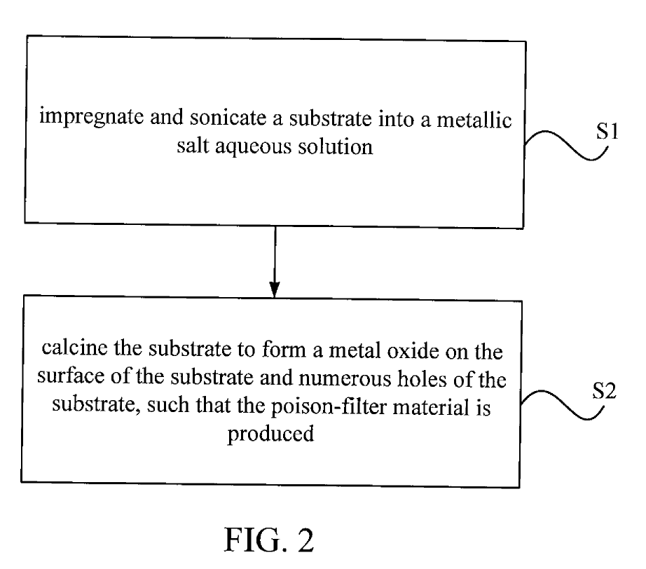

The invention provides a production method for producing a poison-filter material, and the production method includes the following steps, as shown in FIG. 2.

Firstly, step S1 is performed to oscillate and impregnate a substrate into a metallic salt aqueous solution.

Afterward, step S2 is performed to sinter the substrate to form a metal oxide on a surface of the substrate and several holes of the substrate, such that the poison-filter material is produced.

In step S1, the metallic salt aqueous solution is a nitrate aqueous solution. The nitrate aqueous solution is selected from the group consisting of a cobalt nitrate aqueous solution, an aluminum nitrate aqueous solution, a magnesium nitrate aqueous solution, a copper nitrate aqueous solution, a ferric nitrate aqueous solution, a zinc nitrate aqueous solution, and a nickel nitrate aqueous solution. The molar concentration of the nitrate salt aqueous solution is 0.05˜0.5 mole/L. The impregnating time is 24˜48 hours.

In step S2, the calcination temperature is 200˜700° C., and the temperature raising rate of the calcination temperature is 10˜30° C./min. The calcination time is 2˜4 hours.

Preferred embodiments of the production method for producing the poison-filter material of the invention are described below.

A. Pre-Treatment for Activated Carbon Fiber Fabric

A suitable amount of the activated carbon fiber fabric is put in the de-ionized water (the volume ratio of the activated carbon fiber fabric to water is in the range from 1:1 to 1:5). Then, the thermal desorption pre-treatment is proceeded for 1˜2 hours, and the temperature is 100±3° C. The activated carbon fiber fabric after thermal desorption is repeatedly washed several times by the de-ionized water, and is placed in the oven at 105±3° C. and then takes 24 hours of persistently drying. The pre-treatment activated carbon fiber fabric is placed in the sealing bag, and then stored in the drying box to be prepared for impregnation.

B. Impregnation and Calcination for Activated Carbon Fiber Fabric

(1) The nitrate salt aqueous solution with the molar concentration of 0.05˜0.50 mole/L is prepared in the conical flask. The activated carbon fiber fabric (phenolic or PAN-precursor activated carbon fiber fabric) with the weight of 1.5˜4.0 g is impregnated in the nitrate salt aqueous solution with the volume of 150˜200 mL.

(2) The conical flask is sealed by a sealing film and placed in the sonication tank with a constant temperature of 30±3° C. The rotating rate is 100 rpm, and the impregnation time is 24˜48 hours.

(3) The activated carbon fiber fabric is taken out of the conical flask. Then the activated carbon fiber fabric is put in the oven with 105±3° C. and then takes 24 hours of persistently drying. Then, the drying activated carbon fiber fabric is put in the drying box.

(4) The activated carbon fiber fabric after impregnation is put in a high-temperature furnace with nitrogen, and is heated to 200˜700° C. for thermal process. The rising rate of the temperature is 10˜30° C./min, and the heating time is 2˜4 hours.

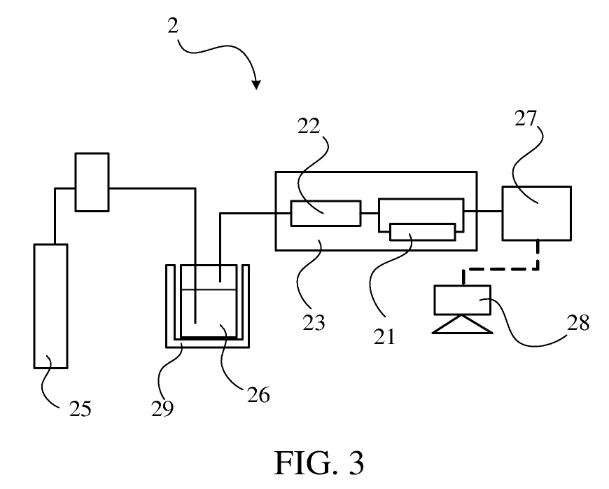

Dynamic absorption testing procedure is described below, and the dynamic absorption testing device 2 is shown in FIG. 3.

(1) The activated carbon fiber fabric is filled into the center of the absorption tube 21 (the number of packed layers is 24). The stainless mesh supports the activated carbon fiber fabric, and the rest space of the tube is filled with glass beads. The absorption tube 21 and the gas mixing tank 22 are placed in the water tank 23 with the constant temperature 30±3° C.

(2) The float flow-meter 24 is used for controlling the volume flow rate and the diluted gas volume flow rate of nitrogen flowing from the steel bottle 25 to the saturated bottle 26. The required concentration of acetaldehyde (concentration is 50˜300 ppmv, relative humidity (RH)<5%) is measured and prepared according to the gas chromatography (GC)/flame ionization detector (FID) 27, and the GC is connected to a computer 28. The total volume flow rate is 1000˜3000 mL/min.

(3) After the gases are mixed uniformly and stably, a three-way valve (not shown) is switched to the path of the absorption tube 21 for dynamic absorption.

(4) The outlet of the absorption tube 21 is connected to the GC/FID 27 to measure the concentration of acetaldehyde. The temperature of the column is 125° C., the injection port is 130° C., and the detector is 130° C.

(5) The concentration is measured every period of time until the outlet concentration does not change and the breakthrough curve becomes flat, and then the measurement of the concentration can be stopped.

(6) The forward steps are repeated under different impregnated activated carbon fiber fabric and different operation parameters.

Controlled embodiment: activated carbon fiber fabric without impregnation

In this embodiment, the activated carbon fiber fabric without impregnation does not have chemical matter formed on the surface of the fabric. The activated carbon fiber fabric merely absorbs the 100 ppmv acetaldehyde gas by a physical absorption method. The absorption ability is relative to the volumes of mesopores and micropores of the material, and relative to polarity functional group of the material. Therefore, the adsorbent material without impregnation has lower absorption ability per unit than the same material with impregnation. From the testing (experimental) result, the breakthrough time T_{5%} (the time for the outlet concentration/inlet concentration of absorption tube reaching 5%) of the phenolic resin-precursor activated carbon fiber fabric is eight minutes, but the breakthrough time T_{5%} of the PAN-precursor activated carbon fiber fabric is 28 minutes. Both absorption abilities per unit respectively are 0.1820 and 0.2411 mmol/g-ACC. The test results are shown in Table 1.

TABLE 1
activated carbon fiber fabric impregnated with nitrate salt solution
dynamically absorbs acetaldehyde gas

| | | breakthrough | absorption ability | |
|---|---|---|---|---|
| | concentration | time T_{5%} | per unit | scaling |
| material | (mole/L) | (min) | (mmol/g-ACC) | factor |
| phenolic | 0 (original | 8 | 0.1820 | — |
| resin- | material) | | | |
| precursor | 0.125 | 32 | 0.5510 | 3.0 |
| | (aluminum | | | |
| | nitrate) | | | |
| PAN- | 0 (original | 28 | 0.2411 | — |
| precursor | material) | | | |
| | 0.25 (cobalt | 36 | 0.3392 | 1.4 |
| | nitrate) | | | |
| | 0.25 | 16 | 0.2244 | 0.9 |
| | (magnesium | | | |
| | nitrate) | | | |

### Embodiment 1: Activated Carbon Fiber Fabric Impregnated with Cobalt Nitrate

After the activated carbon fiber fabric is impregnated in a cobalt nitrate solution, the absorption ability per unit of the impregnated material is slightly larger than the un-impregnated material. PAN-precursor activated carbon fiber fabric is adopted as a raw material, and experimental sample is prepared according to the pre-treatment and impregnation procedure disclosed by the invention. The impregnation solution is the cobalt nitrate aqueous solution with a concentration of 0.25 mole/L. Test results are shown in Table 1, the breakthrough time T_{5%} is 36 minutes, the absorption ability per unit is 0.3392 mmol/g-ACC, and the absorption ability of the activated carbon fiber fabric in this embodiment is 1.4 times as much as original material.

### Embodiment 2: Activated Carbon Fiber Fabric Modified by Tricobalt Tetraoxide

After the activated carbon fiber fabric is impregnated in a cobalt nitrate solution, tricobalt tetraoxide is formed by a high-temperature calcination, to form an absorption material modified by tricobatl tetraoxide. The absorption ability per unit of this material is distinctly larger than the un-treated activated carbon fiber fabric. Phenolic resin-precursor and PAN-precursor activated carbon fiber fabric are respectively taken as raw materials, and experimental samples are prepared according to the pre-treatment, impregnation, and calcination procedures disclosed by the invention. The impregnation solutions respectively are cobalt nitrate solutions with a concentration of 0.125 mole/L and 0.25 mole/L. The calcination temperatures respectively are 300° C., 450° C., and 600° C. Test results are shown in Table 2.

TABLE 2
activated carbon fiber fabric modified by tricobalt tetraoxide absorbs
acetaldehyde gas

| | concen- | | | absorption | |
|---|---|---|---|---|---|
| | tration | | | ability per | |
| | of cobalt | calcination | breakthrough | unit | |
| | nitrate | temperature | time | (mmol/g- | scaling |
| material | (mole/L) | (° C.) | T_{5%} (min) | ACC) | factor |
| phenolic | 0 (original | — | 8 | 0.1820 | — |
| resin- | material) | | | | |
| precursor | 0.125 | 300 | 79 | 1.1599 | 6.4 |
| | 0.125 | 450 | 99 | 1.2489 | 6.9 |
| | 0.125 | 600 | 106 | 1.3592 | 7.5 |
| PAN- | 0 (original | — | 28 | 0.2411 | — |
| precursor | material) | | | | |
| | 0.25 | 300 | 156 | 1.6323 | 6.8 |
| | 0.25 | 450 | 220 | 2.0923 | 8.7 |
| | 0.25 | 600 | 246 | 2.1759 | 9.0 |

### Embodiment 3: Activated Carbon Fiber Fabric Impregnated with Aluminum Nitrate

After the activated carbon fiber fabric is impregnated in an aluminum nitrate solution, the absorption ability per unit of this treated material is distinctly larger than the un-treated activated carbon fiber fabric. Phenolic resin-precursor activated carbon fiber fabric is taken as raw material, and experimental samples are prepared according to the pretreatment and impregnation procedure disclosed by the invention. The impregnation solution is a cobalt nitrate solution with concentration of 0.125 mole/L. The testing results are shown in Table 1, the breakthrough time T_{5%} is 32 minutes, the absorption ability per unit is 0.5510 mmol/g-ACC, and the absorption ability of the activated carbon fiber fabric in this embodiment is 3.0 times as much as original material.

### Embodiment 4: Activated Carbon Fiber Fabric Modified by Aluminum Oxide

After the activated carbon fiber fabric is impregnated in an aluminum nitrate solution, aluminum oxide is formed by a high-temperature calcination, to form an absorption material modified by aluminum oxide. The absorption ability per unit of this material is distinctly larger than the un-treated activated carbon fiber fabric. Phenolic resin-precursor and PAN-precursor activated carbon fiber fabric are respectively taken as raw materials, and experimental samples are prepared according to the pre-treatment, impregnation, and the calcination procedure disclosed by the invention. The impregnation solutions respectively are aluminum nitrate solutions with a concentration of 0.125 mole/L and 0.25 mole/L. The calcination temperatures respectively are 200° C., 400° C., and 600° C. Test results are shown in Table 3.

TABLE 3
activated carbon fiber fabric modified by aluminum oxide absorbs
acetaldehyde gas

| | concen- | | | absorption | |
|---|---|---|---|---|---|
| | tration of | | | ability per | |
| | aluminum | calcination | breakthrough | unit | |
| | nitrate | temperature | time | (mmol/g- | scaling |
| material | (mole/L) | (° C.) | T_{5%} (min) | ACC) | factor |
| phenolic | 0 (original | — | 8 | 0.1820 | — |
| resin- | material) | | | | |
| precursor | 0.125 | 200 | 58 | 1.1738 | 6.5 |
| | 0.125 | 400 | 75 | 1.3570 | 7.5 |
| | 0.125 | 600 | 77 | 1.3965 | 7.7 |
| | 0.25 | 200 | 67 | 1.5469 | 8.6 |
| | 0.25 | 400 | 97 | 2.0334 | 11.3 |
| | 0.25 | 600 | 105 | 2.0963 | 11.5 |
| PAN- | 0 (original | — | 28 | 0.2411 | — |
| precursor | material) | | | | |
| | 0.125 | 400 | 90 | 0.9766 | 4.1 |
| | 0.25 | 400 | 120 | 1.1742 | 4.9 |

### Embodiment 5: Activated Carbon Fiber Fabric Impregnated with Magnesium Nitrate

After the activated carbon fiber fabric is impregnated in a magnesium nitrate solution, the absorption ability per unit of this treated material is slightly smaller than the un-treated activated carbon fiber fabric. PAN-precursor activated carbon fiber fabric is adopted as a raw material, and experimental samples are prepared according to the pre-treatment and impregnation procedure disclosed by the invention. The impregnation solution is a magnesium nitrate solution with a concentration of 0.25 mole/L. The testing results are shown in Table 1, the breakthrough time T_{5%} is 16 minutes, the absorption ability per unit is 0.2244 mmol/g-ACC, and the absorption ability of the activated carbon fiber fabric in this embodiment is 0.9 times as much as the original material.

### Embodiment 6: Activated Carbon Fiber Fabric Modified by Magnesia

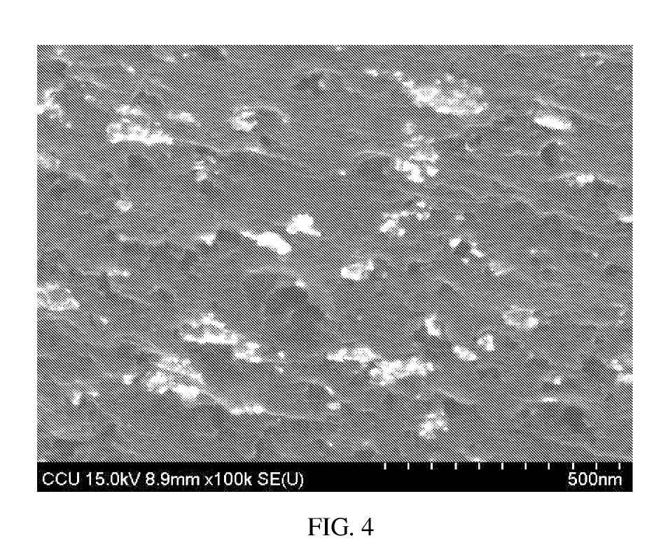

After the activated carbon fiber fabric is impregnated in a magnesium nitrate solution, an absorption material modified by magnesia is formed by high-temperature calcination. The absorption ability per unit of this material is distinctly larger than the un-treated activated carbon fiber fabric. Phenolic resin-precursor and PAN-precursor activated carbon fiber fabric are respectively adopted as raw materials, and experimental samples are prepared according to the pre-treatment, impregnation, and calcination procedure disclosed by the invention. The impregnation solutions respectively are magnesium nitrate solutions with a concentration of 0.125 mole/L and 0.25 mole/L. The calcination temperatures respectively are 200° C., 400° C., and 600° C. Test results are shown in Table 4. After the activated carbon fiber is impregnated in magnesium nitrate with a concentration of 0.25 mole/L, and then sintered at 400° C. and sintered for 2 hours, the scanning electron microscope (SEM) figure of the activated carbon fiber modified by magnesia is shown as FIG. 4.

TABLE 4
activated carbon fiber fabric modified by magnesia absorbs
acetaldehyde gas

| | concen- | | | absorption | |
|---|---|---|---|---|---|
| | tration of | calcination | | ability per | |
| | magnesium | temper- | breakthrough | unit | |
| | nitrate | ature | time | (mmol/g- | scaling |
| material | (mole/L) | (° C.) | T_{5%} (min) | ACC) | factor |
| phenolic | 0 (original | — | 8 | 0.1820 | — |
| resin- | material) | | | | |
| precursor | 0.125 | 200 | 28 | 0.4553 | 2.5 |
| | 0.125 | 400 | 141 | 2.4710 | 13.6 |
| | 0.125 | 600 | 153 | 2.5552 | 14.0 |
| | 0.25 | 200 | 27 | 0.6067 | 3.3 |
| | 0.25 | 400 | 176 | 2.5725 | 14.1 |
| | 0.25 | 600 | 175 | 2.7865 | 15.3 |
| PAN- | 0 (original | — | 28 | 0.2411 | — |
| precursor | material) | | | | |
| | 0.125 | 200 | 33 | 0.4917 | 2.0 |
| | 0.125 | 400 | 147 | 1.5305 | 6.3 |
| | 0.125 | 600 | 183 | 1.9390 | 8.0 |
| | 0.25 | 200 | 37 | 0.5782 | 2.4 |
| | 0.25 | 400 | 224 | 2.1137 | 8.8 |
| | 0.25 | 600 | 216 | 2.2804 | 9.5 |

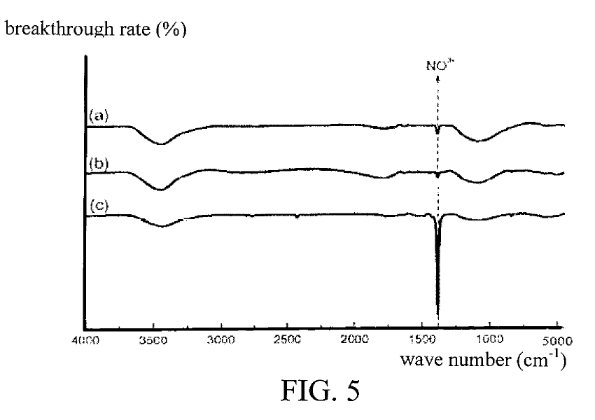

FIG. 5 is a FTIR spectrum of the activated carbon fiber fabric, wherein the curve (a) corresponds to original activated carbon fiber fabric, the curve (b) corresponds to the activated carbon fiber fabric modified by magnesia, and the curve (c) corresponds to activated carbon fiber fabric modified by magnesium nitrate.

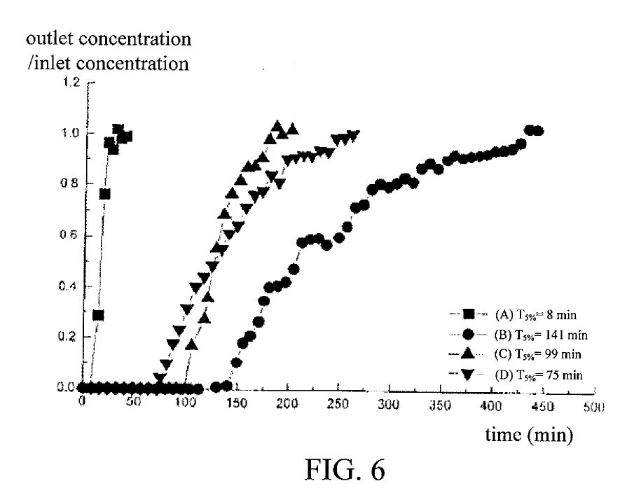

FIG. 6 is a breakthrough time curve of phenolic resin-precursor activated carbon fiber fabric for dynamically absorbing acetaldehyde, wherein the curve (a) corresponds to original activated carbon fiber fabric (absorption ability per unit is 0.1820 mmol/g-Acc), the curve (b) corresponds to activated carbon fiber fabric modified by magnesia (absorption ability per unit is 2.4710 mmol/g-ACC), the curve (c) corresponds to activated carbon fiber fabric modified by tricobalt tetraoxide (absorption ability per unit is 1.2489 mmol/g-ACC), and the curve (d) corresponds to activated carbon fiber fabric modified by aluminum oxide (absorption ability per unit is 1.3570 mmol/g-ACC). When the ratio of the concentration near the outlet of the absorption tube to the concentration near the inlet reaches 1.0, it means that the adsorbent material is fully penetrated by the acetaldehyde.

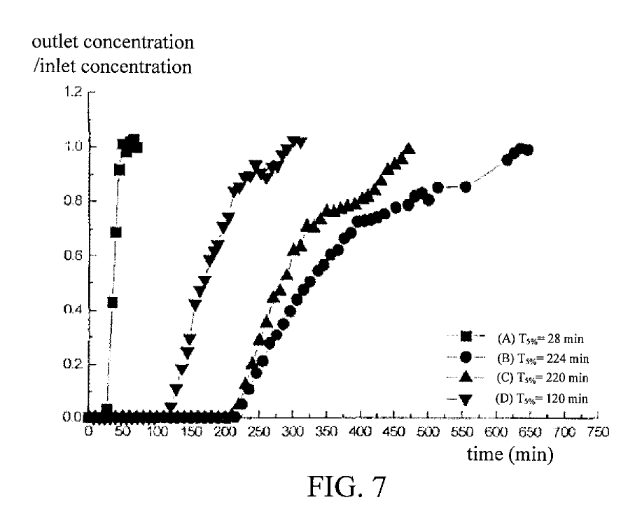

FIG. 7 is a breakthrough time curve of PAN-precursor activated carbon fiber fabric for dynamically absorbing acetaldehyde, wherein the curve (a) corresponds to original activated carbon fiber fabric (absorption ability per unit is 0.2411 mmol/g-Acc), the curve (b) corresponds to the activated carbon fiber fabric modified by magnesia (absorption ability per unit is 2.1137 mmol/g-ACC), the curve (c) corresponds to the activated carbon fiber fabric modified by tricobalt tetraoxide (absorption ability per unit is 2.0923 mmol/g-ACC), and the curve (d) corresponds to activated carbon fiber fabric modified by aluminum oxide (absorption ability per unit is 1.1742 mmol/g-ACC).

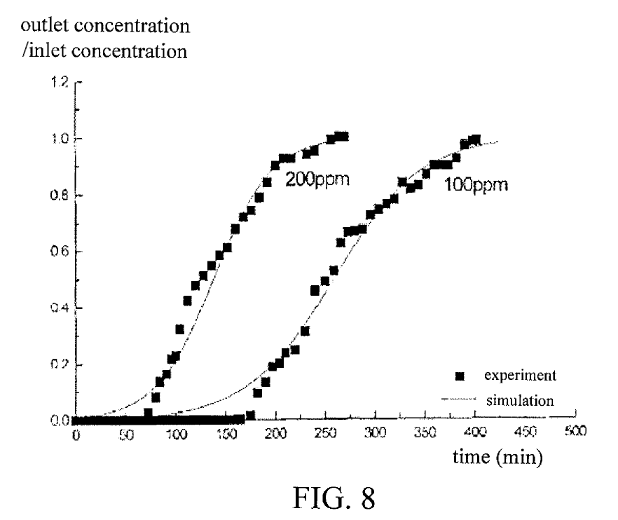

FIG. 8 is a breakthrough time curve of activated carbon fiber fabric modified by magnesia for absorbing acetaldehydes respectively with initial concentration of 100 ppmv and 200 ppmv, wherein temperature is 303K, and the volume flow is 2.1L/min.

In summary, the invention provides a poison-filter material and the production method thereof. In the invention, the metallic salt aqueous solution (e.g. nitrite salt aqueous solution) is fully oscillated to impregnate the porous substrate (e.g. activated carbon fiber with holes), and metal oxide is formed on the surface and holes of the substrate after high-temperature calcination. Therefore, the adsorbent material of the invention can effectively adsorb noxious gas and lower penetrability of noxious gas. During the calcination process, the metallic salt aqueous solution of the invention does not generate harmful volatility solvents such as ammonia. Therefore, the invention can prevent the production process from polluting the environment, harming the health of operator, and reduces the cost for recycling harmful volatility solvents.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A poison-filter material, comprising:
a substrate, comprising a plurality of holes; and
a metal oxide, adhered to a surface of the substrate and the holes.

2. The poison-filter material of claim 1, wherein the substrate is an activated carbon substrate.

3. The poison-filter material of claim 2, wherein the activated carbon substrate is selected from the group consisting of a granular activated carbon, a columnar activated carbon, and a fibrous activated carbon.

4. The poison-filter material of claim 3, wherein a surface to volume ratio of the fibrous activated carbon is larger than or equal to 1500 m²/g.

5. The poison-filter material of claim 3, wherein a diameter of the fibrous activated carbon is smaller than or equal to 2 nm.

6. The poison-filter material of claim 3, wherein a plurality of fibrous activated carbons constitute an activated carbon fiber fabric.

7. The poison-filter material of claim 6, wherein the activated carbon fiber fabric is selected from the group consisting of a phenolic-precursor activated carbon fiber fabric and an acrylic activated carbon fiber fabric.

8. The poison-filter material of claim 7, wherein the preferred activated carbon fiber fabric is the acrylic activated carbon fiber fabric.

9. The poison-filter material of claim 1, wherein the metal oxide is selected from the group consisting of a cobalt oxide, an aluminum oxide, a magnesia, a copper oxide, a ferric oxide, a zinc oxide, and a nickel oxide.

10. The poison-filter material of claim 9, wherein the cobalt oxide is a tricobalt tetraoxide.

11. The poison-filter material of claim 10, wherein a preferred metal oxide is magnesia among the tricobalt tetraoxide, the aluminum oxide, and the magnesia.

12. A production method for producing a poison-filter material, comprising following steps of:
sonicating and impregnating a substrate into a metallic salt aqueous solution; and
calcining the substrate to form a metal oxide adhered to a surface of the substrate and a plurality of holes of the substrate, such that the poison-filter material is produced.

13. The production method of claim 12, wherein the metallic salt aqueous solution is a nitrate aqueous solution.

14. The production method of claim 13, wherein the nitrate aqueous solution is selected from the group consisting of a cobalt nitrate aqueous solution, an aluminum nitrate aqueous solution, a magnesium nitrate aqueous solution, a copper nitrate aqueous solution, a ferric nitrate aqueous solution, a zinc nitrate aqueous solution, and a nickel nitrate aqueous solution.

15. The production method of claim 14, wherein a molar concentration of the nitrate salt aqueous solution is 0.05˜0.5 mole/L.

16. The production method of claim 12, wherein a calcination temperature in the step of calcining the substrate is 200˜700° C.

17. The production method of claim 12, wherein a temperature raising rate of a calcination temperature in the step of calcining the substrate is 10˜30° C./min.

18. The production method of claim 12, wherein a calcination time in the step of calcining the substrate is 2˜4 hours.

19. The production method of claim 12, wherein a sonication and impregnating time in the step of sonicating and impregnating the metallic salt aqueous solution is 24˜48 hours.

20. The production method of claim 12, wherein when the substrate is an activated carbon fiber fabric composed of fibrous activated carbons, and the metallic salt aqueous solution is a nitrate aqueous solution, the activated carbon fiber fabric with 1.5˜4.0 g is oscillated and impregnated in the nitrate aqueous solution with 150˜200 mL.
